(19) United States
(12) Patent Application Publication
(10) Pub. No.: US 2015/0198316 A1
(43) Pub. Date: Jul. 16, 2015

(54) Stack Light with Modular Function Generator

(71) Applicant: ROCKWELL AUTOMATION TECHNOLOGIES, INC., Mayfield Heights, OH (US)

(72) Inventors: Robert P. Feller, Franklin, WI (US); Darrell S. Filtz, Cedarburg, WI (US); Will J. Preischel, Racine, WI (US); Alvaro Sanchez, Franklin, WI (US); Yutao Wang, Brookfield, WI (US)

(73) Assignee: ROCKWELL AUTOMATION TECHNOLOGIES, INC., Mayfield Heights, OH (US)

(21) Appl. No.: 14/153,561

(22) Filed: Jan. 13, 2014

(51) Int. Cl. F21V 23/02; F21V 23/06; H05B 37/02

(52) U.S. Cl. CPC F21V 23/023; H05B 37/0281; F21V 23/06

(57) ABSTRACT

A function generator is introduced into a stack light in the form of a compatible modular element that fits between the base and a light module. By centralizing the operation of the function generator, fewer components must be separately stocked and a cost savings may be realized through the centralized function generator.

### BACKGROUND OF THE INVENTION

The present invention relates to “stack lights”, a visual display used to convey operation and warning information in an industrial environment and, in particular, to a stack light that includes a modular power converter serving to greatly reduce the number of stocked components needed to provide different stack light configurations.

Stack lights provide a short tower of different colored lamps, such as may be attached to, or placed in close proximity to, operating industrial equipment to provide a visible indication of the equipment operating status. The tower structure ensures good visibility of the beacon lights over a range of angles and locations in the operating environment. Different colors of the lights allow multiple types of information to be communicated at a distance in a possibly noisy environment. For example, a red light may indicate a machine failure or emergency, a yellow light may indicate a warning such as over-temperature or over-pressure and green may indicate machine operation, etc.

Stack lights are typically constructed of modular components that may be flexibly interconnected to produce stack lights with different colors, color order and stack heights. Beacon modules, each providing a single color lamp, may be stacked one on top of another, the bottom beacon module supported on a modular base unit.

Each beacon module includes an electric light source (for example an incandescent or LED assembly) held within a transparent housing, for example a cylindrical tube of colored plastic, through which the light source may be viewed. Upper and lower mechanical connectors on each beacon module allow the beacon modules to be joined into the tower described above. Each beacon module also includes an upper and lower mechanical connector and internal electrical conductors that communicate electrical signals from the bottom of the module to its top. The connectors and conductors operate so that when the beacon modules are assembled together, electrical continuity is established along the height of the tower between the base and the various modules without the need for separate wiring operations.

As noted the multiple beacon modules are supported on a lower base module. The base module may provide a wire terminal block receiving electrical wiring from an externally switched power source intended to control the lighting of the different beacon modules. The externally switched power source may, for example, be provided by an I/O module or other programmable industrial control unit. Important status information developed during the execution of a control program on the industrial control unit may be relayed to the stack light through the I/O module for display to human operators.

In normal wiring practices, the base module of the stack light receives a power “common” together with multiple “signal lines” each identified to one of the different beacon modules. A given beacon module is turned on when its corresponding signal line is energized. The electrical continuity as established by the electrical connector and conductor system of the beacon modules, described above, routes each signal line from the base module to a single beacon module input.

The usefulness and popularity of stack lights has led to a wide variety of configurations of the basic stack light components. As a starting point, the modular components may be offered in different tower diameters (e.g. 30 mm, 40 mm, 50 mm, 60 mm, 70 mm and 100 mm). In each of these diameter classes, a variety of different base modules are normally offered to permit mounting of the tower to different surfaces, for example to a horizontal surface to extend upward therefrom or to the side of a vertical wall or the like. Different base heights are also normally provided as well as different mechanical attachment structures. Also in each diameter class, the beacon module may be offered in different colors (e.g. green, red, amber, blue, clear, and yellow), with different lamp types (LED/incandescent/strobe), different function capabilities (e.g. flashing, rotation) and power supply requirements (12 V. 24 V, 120 V, 250 volt, AC or DC).

While modularity of the stack light instruction is intended to provide a customer with the ability to rapidly fabricate a wide variety of different stack light types out of readily available (stocked) components, the large number of component variations can undercut this goal by leading to an impractically large number of different modules. For example, in order to provide the customer with each of the choices described above, with colors, voltages, dimensions etc., many hundreds of different types of pre-manufactured modules may be necessary.

### SUMMARY OF THE INVENTION

The present invention provides a modular function generator providing flashing and other animation effects to stack light beacons. Providing the function generator in a freestanding module, separate from the base or beacon modules which it controls, reduces the number of variations of bases and/or beacon modules that must be stocked to obtain a full range of functions and further permits functions to be synchronized among multiple beacon modules. When multiple beacon modules need function affects, centralized function circuitry reduces costs. Power for centralized function modules may be obtained by scavenging power from various control signals. The centralized function module may be combined with a centralized voltage converter to obtain additional advantages in reduced cost and in reducing the variety of stocked components.

Specifically then, the present invention provides a function generator for use in a stack light of the type providing a set of beacon modules interlocking to each other and to a base unit by means of interlocking mechanical connectors and interfitting electrical connectors positioned at a top and bottom of each beacon module and at a top of the base unit together allowing multiple beacon modules and one base to be mechanically and electrically assembled into a tower with electrical communication between the base and each beacon module. The function generator includes housing having first and second mechanical connectors positioned at a top and bottom of the housing and adapted to releasably interlock with corresponding mechanical connectors of beacon modules and a base. The top and bottom of the housing also provide first and second electrical connectors adapted to releasably interface with corresponding electrical connectors of beacon modules and a base. A function generation circuit is positioned within the housing to receive electrical power from the second electrical connector and to generate a time-modulation signal to provide time-modulated electrical power to the first electrical connector based on that time-modulated signal.

It is thus a feature of at least one embodiment of the invention to segregate the functional capabilities of the stack light into a centralized modular component eliminating or reducing the proliferation of different stack light components necessary to provide a range of functions (or no function).

The function generator may include an oscillator providing a time reference for the time-modulation signal.

It is thus a feature of at least one embodiment of the invention to reduce stack light costs by sharing a common time source.

The function generator may include a switch communicating with the function generator circuit to change the time-modulated signal.

It is thus a feature of at least one embodiment to leverage a centralization of function generation to provide a more sophisticated multi-modulation unit having switch selectivity.

The time-modulated electrical power may be provided to multiple different conductors of the first electrical connector adapted to communicate with different beacon modules and the switch may select which of the different electrical connectors receive modulated electrical power based on the time-modulated signal.

It is thus a feature of at least one embodiment of the invention to provide centralization of function generation capabilities while still allowing individual selection of functions on individual beacons.

The time-modulation signal may provide synchronized modulation to the different conductors of the first electrical connector.

It is thus a feature of at least one embodiment of the invention to permit synchronization among generated functions across beacons for additional visual impact.

The time-modulation signal may provide synchronized different modulation to the different conductors of the first electrical connector.

It is thus a feature of at least one embodiment of the invention to provide for sophisticated modulation techniques such as flashing that proceeds through the beacons in order, either with equal flash on times or “stacked” flash times where the beacons have different on times and the same off time.

The housing may further include a power conversion circuit positioned within the housing and receiving electrical power from the second electrical connector having a parameter of at least one of voltage and mode to provide converted power to the function generator circuit for generation of the time-modulated electrical power.

It is thus a feature of at least one embodiment of the invention to permit the generation of power for the function generator as derived from the signal lines received by the stack light.

The first and second electrical connectors may be of a same connector type such as would permit inter-engagement of the separated first and second electrical connectors and the first and second mechanical connectors are of a same connector type such as would permit entry engagement of the separated first and second mechanical connectors.

It is thus a feature of at least one embodiment of the invention to provide a modular function generator conforming to the order-free connect system of a conventional stack light so as to permit the power converter to be integrated into an existing stack light systems when function generation is desired or omitted from a given stack light system when function generation is not required.

The housing may be substantially cylindrical and have a diameter substantially between 30 and 100 mm.

It is thus a feature of at least one embodiment of the invention to provide a function generator that visually integrates into conventional stack light towers.

The housing may be substantially opaque and electrically insulating.

It is thus a feature of at least one embodiment of the invention to provide function generation separate from the beacon modules where issues of light transmission would limit circuitry options.

The power conversion circuit may receive signal lines from the second electrical connector and provide a source of electrical power derived from the signal lines to the function circuitry of the power conversion circuit, the function circuitry further modulating power on at least one signal line provided to the first electrical connector.

It is thus a feature of at least one embodiment of the invention to permit a centralized function generator without the presence of a consistent power signal received by the stack light.

These particular features and advantages may apply to only some embodiments falling within the claims and thus do not define the scope of the invention.

### BRIEF DESCRIPTION OF THE DRAWINGS

FIG. 1 is a perspective view of a stack light assembled of several beacon modules, a power-converter/function module and a base module, juxtaposed with alternative unassembled modules;

FIG. 2 is a fragmentary, exploded, elevational cross-section of the stack light of FIG. 1 showing mechanical and electrical connection of the various modules;

FIG. 3 is a schematic representation of the circuitry of FIG. 2 showing principal functional blocks of the power-converter/function module including a power converter circuit and modulation function circuit;

FIG. 4 is a detailed block diagram of the function module of FIG. 3 including a timing state machine and AND-gate modulator;

FIGS. 5a and 5b are timing diagrams of the outputs of the timing state machine of FIG. 4 for two modes of operation in which lamps from different beacon modules are synchronized; and

FIG. 6 is a schematic similar to that of FIG. 3 showing an alternative configuration power converter circuit with direct power supply access.

### DETAILED DESCRIPTION OF THE PREFERRED EMBODIMENT

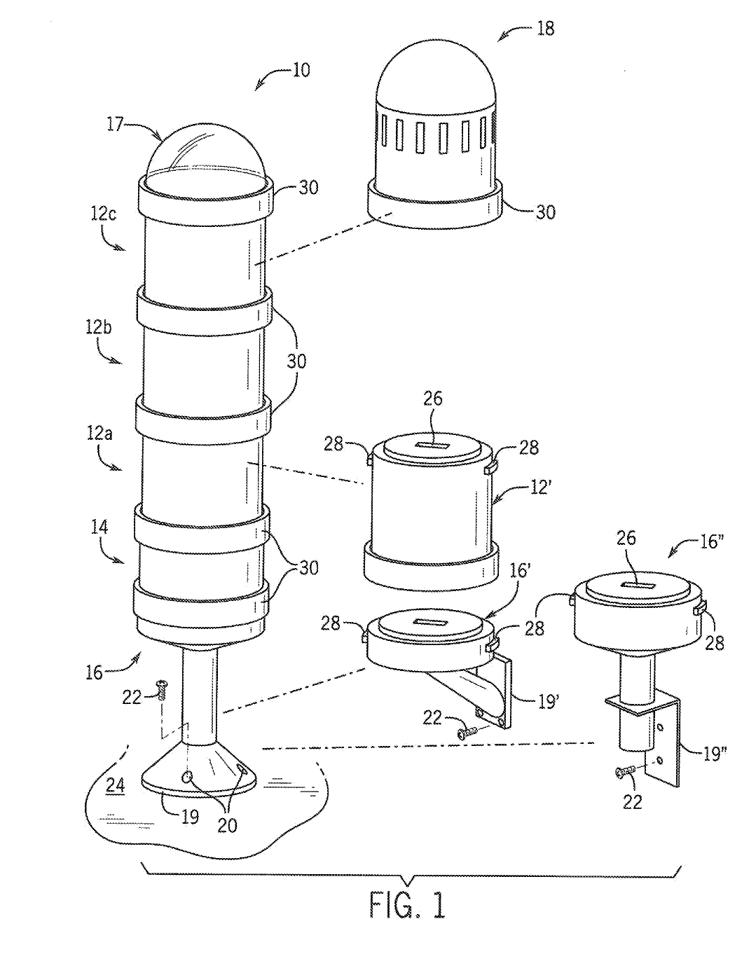

Referring now to FIG. 1, a stack light 10 constructed according to the present invention may be assembled of multiple interlocking beacon modules 12a, 12b, 12c, a power-converter/function module 14, and a base module 16.

In one embodiment, the lowest most element of the base module 16 may provide a lower flange 19 having one or more openings 20 for receiving machine screws 22 or the like to fasten the flange 19 and hence the base module 16 to a surface 24 of a machine or the like. Alternative base module 16′ and 16″ may provide for different flanges 19′ and 19″ respectively (for example for mounting the vertical surfaces) or for accommodating different base constructions.

The upper surface of the base module 16 may expose a centered electrical connectors 26 (visible in FIG. 1 only on base module 16′ and 16″) that may be received by a corresponding electrical connector 26 (not visible in FIG. 1) on the lower surfaces of each of the beacon modules 12, power-converter/function module 14 and audio alarm module 18. Similar connectors 26 exist on the upper surface of each of the other modules the beacon modules 12, and power-converter/function module 14 (visible in FIG. 1 only on beacon module 12). Inter-engagement of these electrical connectors 26 in the assembled stack light 10 provide electrical communication between each of the base module 16 beacon modules 12, power-converter/function module 14 and audio alarm module 18 as will be described.

The upper end of the base module 16 also provides a portion of a mechanical interlocking system in the form of radially extending tabs 28 (visible in FIG. 1 only on base module 16′ and 1 6″). These radially extending tabs 28 may be received by a second portion of the mechanical interlocking system in the form of twist type bayonet rings 30 rotatably affixed to the lower surfaces of each of the beacon modules 12, and power-converter/function module 14. Such bayonet rings 30, as generally understood in the art, provide features on their inner diameter that may capture the radially extending tabs 28 against a helical flange in the manner of inter-engaging threads while providing a slight pocket at the end of rotation forming a detent that locks the tabs 28 and bayonet rings 30 into predetermined compression,

Similar radially extending tabs 28 exist at the upper end of each of the other modules the beacon modules 12, power-converter/function module 14 and audio alarm module 18 (visible in FIG. 1 only on beacon module 12′). Inter-engagement of these tabs 28 and bayonet rings of other modules in the assembled stack light 10 provide permit mechanical interconnection between any of the base module 16, the beacon modules 12, and the power-converter/function module 14 into the stack light 10.

As assembled the base module 16, the beacon modules 12, the power-converter/function module 14 and the audio alarm module 18 provide a tower extending generally upward from the base module 16 through power-converter/function module 14, then through one or more beacon modules 12 each of which may independently controlled to display a predetermined color illumination.

As depicted in FIG. 1, the tower may be capped by a plastic dome 17 also having a bayonet ring 30 but no electrical connector 26. Alternatively, an audio alarm module 18 operating in a manner similar to that of the beacon modules 12 but providing an audible alarm through sound ports 21 rather than an illuminated signal may replace the final beacon module 12c. Like the other modules, the audio alarm module 18 may include a bayonet ring 30 on its lower end for attachment to a lower module, and an electrical connector 26 on its lower surface for electrical interconnection to an earlier lower module. Desirably, the audio alarm module 18 may have a dome top without a connector 26 or tabs 28 on its top surface for attachment to later modules, thereby providing a finished appearance to the top of the tower.

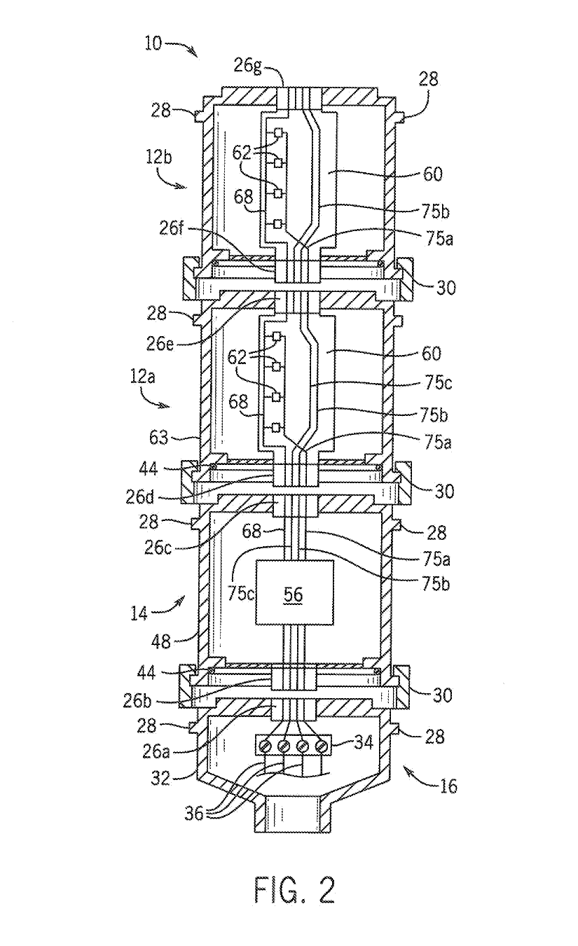

Referring now to FIG. 2, base module 16 may provide a housing 32, for example, constructed of electrically insulating and opaque thermoplastic. The housing 32 may provide a cylindrical periphery in diameter generally matching the diameter of corresponding housings of the beacon modules 12, power-converter/function module 14 and audio alarm module 18. Standard diameters for stack lights 10 include 30 mm, 40 mm, 50 mm, 60 mm, 70 mm and 100 mm.

A terminal block 34 may be positioned within the housing 32 of the base module 16, for example, providing screw terminals, to receive conductors 36 from a remote switching device as will be discussed below. Each of the conductors 36, when attached to the terminal block 34, will be routed to the electrical connector 26a exposed at an upper surface of the base module 16. This electrical connector 26a receives a downwardly extending connector 26b from power-converter/function module 14 when it is connected to base module 16. Electrical connectors 26a and 26b, for example, may be male and female versions of the same connector to be mechanically inter-engageable or may be identical connector reoriented as in the case of hermaphrodite connector systems.

For simplicity, the electrical connectors 26a and 26b (and all connectors 26 in FIG. 2) are depicted with only four conductive inserts 42 (for example, conductive pins or sockets) or which may each receive a separate conductor 36. As is understood in the art, each conductive insert 40 provides an electrically independent conductive paths within mating electrical connectors 26.

As noted, the upper edge of the base module 16 provides for radially extending tabs 28 that may be received by a bayonet ring 30 rotatably attached to the bottom of power-converter/function module 14. In this way the base module 16 may be electrically and mechanically attached to the power-converter/functional module 14 with connectors 26a and 26b joined. An O-ring seal 44 may be provided at the junction between the upper surface of base module 16 and the lower surface of power-converter/function module 14 to reduce the ingress of environmental contamination when the two are connected.

Referring still to FIG. 2, power-converter/function module 14 may provide for a opaque housing 48 supporting at its upper surface connector 26c being substantially identical connector 26a and exposed to receive a connector 26d when beacon module 12a is attached to the upper surface of the power-converter/function module 14. As described above this connection may be by means of radially extending tabs 28 at the upper edge of power-converter/function module 14 received by a corresponding bayonet ring 30 of beacon module 12a.

As will be discussed in greater detail below, power-converter/function module 14 includes power converter/function circuitry 56 that receives electrical power from connector 26b to convert this electrical power into a backbone voltage for use with the later beacon modules 12 and audio alarm module 18. In this way beacon modules 12 and audio alarm modules 18 having common voltage parameters (e.g. the same voltage and the same voltage mode of either AC or DC) can be used with stack lights 10 receiving any operating voltage. Power converter/function circuitry 56 further provides for the ability to impose modulation functions such as lamp flashing or module sequencing on the later beacon modules 12 and audio alarm module 18 by modulating the power received by those modules. This eliminates the need for those modules to each include circuitry for modulation functions.

In various configurations that will be discussed below, the power converter/function circuitry 56 will receive operating electrical power and multiple signal lines through electrical connector 26b as derived from conductors 36. From this, the power converter/function circuitry 56 establishes a backbone ground reference on “common” conductor 68 and multiple signal voltages for control of beacon modules 12 or audio alarm module 18 on conductors 75a-75c (typically up to seven conductors although only three are shown for clarity in this example). The common conductor 68 and signal conductors 75 are connected to electrical connector 26c, for example, as depicted in right to left order of signal conductors 75a, 75b, 75c and common conductor 68.

Referring still the FIG. 2, connector 26d in subsequent beacon module 12b, may connect to connector 26c and may be attached, for example, to a printed circuit board 60 carrying on it multiple light emitting diodes (LEDs) 62. As shown, LEDs 62 are connected between common conductor 68 and signal conductor 75a occupying the extreme left and right positions of the connector 26d. Accordingly power on signal conductor 75a will energize the LEDs 62 of beacon module 12b so that the light may be viewed through transparent housing 63. The housing 63 may have a tint to provide a desired light color and/or the LEDs 62 may be selected for a desired color.

Although the LEDs 62 are shown connected in parallel, series connections are also possible. Current sharing resistances for each LED 62 have been omitted for clarity.

The upper edge of the circuit board 60 may communicate with connector 26e being identical to connector 26c and 26b. Circuit traces on a printed circuit board 60 provide common conductor 68 join an identical location of connectors 26d and 26e (in the leftmost position as shown in FIG. 1). Signal conductor 75a used to control the LEDs 62 of beacon module 12a does not pass to connector 26e, however, and signal conductors 75b and 75c are shifted one connector position to the right so that signal conductor 75b is now at the rightmost conductive insert 42 of connector 26e.

It will be understood then that beacon module 12b being constructed of electrically and mechanically identical to beacon module 12a may then be attached to beacon module 12a in the same way that beacon module 12a was attach the power-converter/function module 14 and that signal conductor 54b will now be connected to its LEDs 62.

The system illustrated for beacon module 12a and beacon module 12b may be continued to beacon module 12c (not depicted in FIG. 2) so that signal conductors 75a, 75b, and 75c will control the first second and third beacon modules 12 according to their order in the stack and in a manner indifferent to the exact beacon module 12 and without the need for adjustment of the internal wiring of the beacon modules 12a or the setting of internal addresses or the like. The number of conductive inserts 42 in the connector 26 and signal conductors 75 determine the limit of the number of modules 12 may be stacked in this manner.

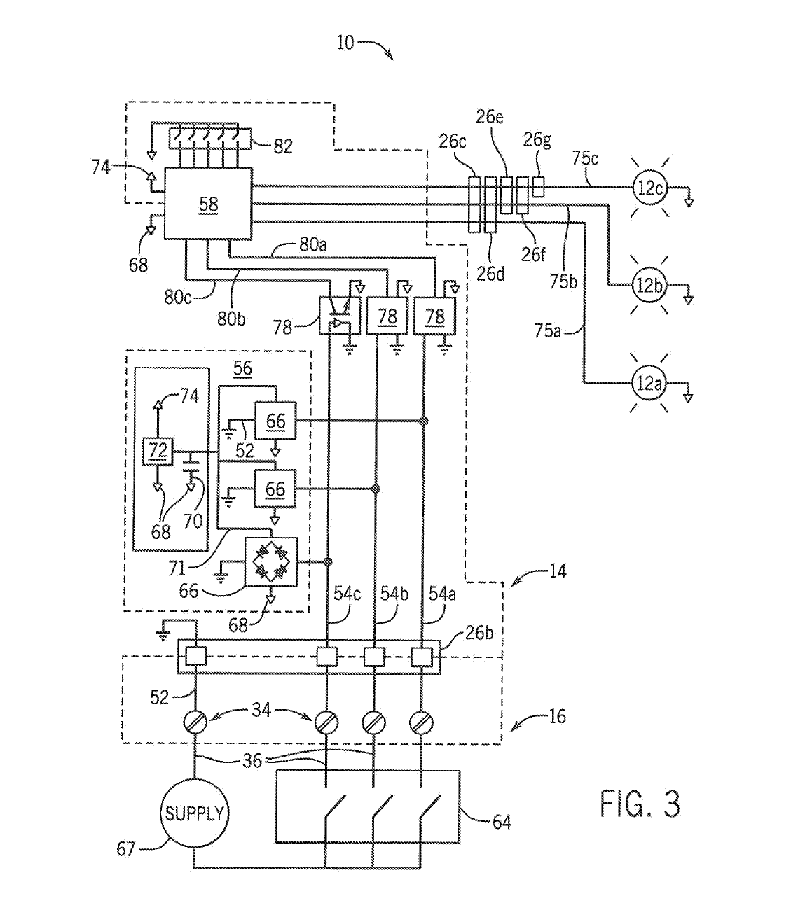

Referring now to FIG. 3, in a first wiring mode of the stack light 10, conductors 36 received by the base module 16 do not provide to the base module 16 direct connections to an external power supply 67 that provides the operating voltage of the stack light 10. This external power supply 67 is normally provided by a customer and may vary in voltage between 12 and 240 V (e.g. 12 V 24 V 120 V 240 V) and may be either AC or DC voltage (termed herein the power supply “mode”). In this wiring mode, the base module 16 receives only a power supply common 52 and multiple switched signal lines 54a-54c representing power from the external power supply 67 only after it has been switched by external switch system 64. The external switch system 64 may be, for example, relays or programmable logic controller I/O module referenced through a power supply 67 to the common 52.

In this embodiment, the power power-converter/function module 14 taps the signal conductors 54 to obtain power for its operation when it least one signal conductor 54 is active. This may be done by attaching a full wave rectifier 66 between each the signal conductors 54 and a common DC bus input line 71. Each full wave rectifier 66 is /configured to steer either DC or AC current is applied to the signal conductors 54 independently from any of the signal conductors 54 to a filter capacitor 70 reference to a backbone common 68 while preventing crosstalk between signal conductors 54.

The filter capacitor 70 is made therefore provide a source of DC voltage regardless of whether AC or DC voltage is provided by the supply 67 for any time a beacon module 12 is to be activated. The effective filter time constant provided by capacitor 70 is chosen to prevent the imposition of any meaningful delay in the generation necessary power once a signal present on anyone of the signal conductors 54. Nevertheless, voltage of the power on capacitor 70 will vary substantially according to the operating voltage of the power supply 67. Accordingly the voltage on the capacitor 70 may then be provided to a voltage regulator 72 uniformly converting that voltage to a least common denominator voltage (e.g. 12 VDC) of local backbone power 74. The voltage regulator 72 may be of any design including, for example, a switched mode regulator is well known in the art. By using a boost mode converter, the voltage of the local backbone power 74 may be in fact higher than 12 V by allowing 12 V power supply voltages of power supply 67 to be boosted appropriately.

The backbone power 74 and backbone common 68 provide power to the modulation function circuit 58 as will be described below in defines the voltage level of the active signal conductors 75 connecting to the beacon modules 12.

As well as scavenging power from the signal conductors 54, the power-converter/function module 14 also extracts the information content on the signal conductors 54 by passing them through optoisolators 78 (one for each conductor 54) which isolate the operating voltage of power supply 67 (in common 52) from the backbone power 74 (and backbone common 68) optically isolated electrical signals 80a, 80b, in 80c (each corresponding to one of conductors 54a, 54b and 54c respectively) are then provided to the modulation function circuit 58 which may modulate those signals when present according to a desired pattern set by user for example, through a dip switch 82 providing signals to modulation function circuit 58.

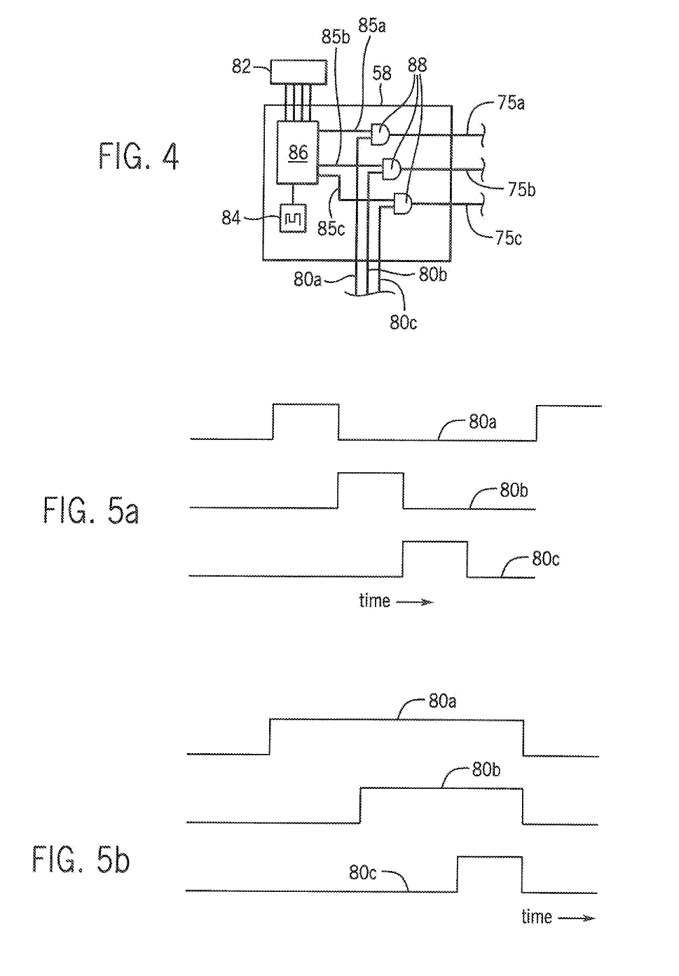

Referring now momentarily to FIG. 4, modulation function circuit 58 may implemented in a variety of different ways including a microcontroller, programmable gate array or discrete logical circuitry and generally includes a modulation clock 84, for example, providing a base modulation frequency. The modulation clock 84 may for example be a conventional RC oscillator and divider circuit to provide a modulation frequency of 1 Hz. The output of the modulation clock is then received by programmable timing state machine 86 whose particular programming (and hence the modulation pattern) is set by switches 82. In one example, three outputs 85a, 85b, and 85c from the timing state machine 86 (for example, such as may control the modulation of signals to beacon modules 12a, 12b, in 12c) may provide identical square waves at the frequency of the clock 84. Each of these outputs may be received by an AND gate 88 whose other input is one of the signals 80a-80c output from the optoisolators 78 indicating the state of activation of the signal conductors 54. This modulation pattern would provide synchronized flashing of any active beacon modules 12. In this case, the modulation pattern would be synchronized and identical among beacon modules 12.

Another modulation provided by switches 82 may provide for steady high state output on each of the four signals 80a-80e of the timing state machine 86 essentially providing no function blinking of the beacon modules 12 when they are activated. It will be understood that some settings of the switches 82, may likewise provide modulation on only some of the signals 80a-80c, so that selected beacons may be modulated and other beacons not modulated. Different modulation patterns (for example frequencies) may be applied to different of the signals 80a-80c.

Alternatively as shown in FIG. 5a, the output signals 80a-80c of the timing state machine 86 may alternately turn high in a round-robin “marquee” pattern so that when multiple beacon modules 12 are activated their illumination expresses an animation, for example, of an upwardly rising single point of illumination that passes successively through each colored beacon.

In contrast, as shown in FIG. 5b, a “stacked” pattern may be implemented in which, for example, an upwardly rising animation is generated but with the lowermost beacon remaining on as successively higher beacons are illuminated until all are ultimately illuminated and then extinguished together and this pattern repeated.

In all of these examples, the flashing of different beacon modules 12 is synchronized in a way that is difficult when the timing circuitry for flashing is localized in the individual beacons themselves. This latter modulation provides modulation patterns that are also synchronized but are not identical. Another similar synchronized but different set of modulation patterns might provide different frequencies for each beacon module 12 but are nevertheless phase synchronized.

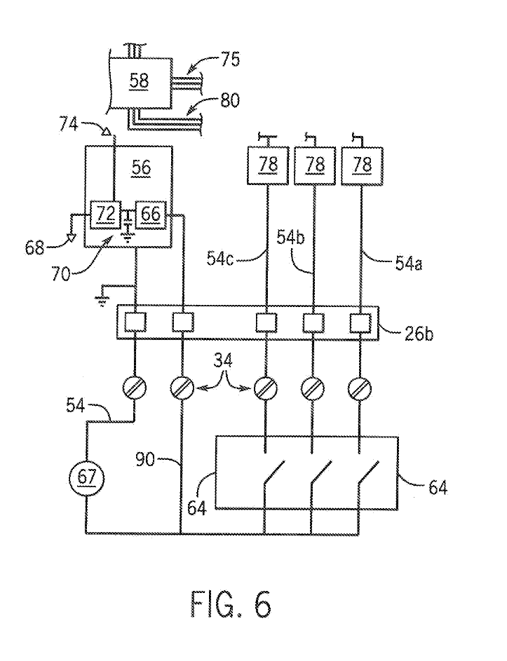

Referring now to FIG. 6, it will be appreciated that the present invention may also work with a dedicated power supply line 90 from the external power supply 67, for example, introduced through a separate screw terminal so that the base module 16 has direct access to constant electrical power through power supply common 52 and power supply line 90. In this case, power may be directed from this power supply line to a single full wave rectifier 66 providing current to capacitor 70.

It will be appreciated that the LEDs 62 may be replaced with incandescent lamps according to well-understood techniques.

Certain terminology is used herein for purposes of reference only, and thus is not intended to be limiting. For example, terms such as “upperu, plower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

It is specifically intended that the present invention not be limited to the embodiments and illustrations contained herein and the claims should be understood to include modified forms of those embodiments, including portions of the embodiments and combinations of elements of different embodiments as come within the scope of the following claims.

I claim:

1. A function generator for use in a stack light of the type providing a set of beacon modules interlocking to each other and to a base unit by means of interlocking mechanical connectors and interfitting electrical connectors positioned at a top and bottom of each beacon module and at a top of the base unit together allowing multiple beacon modules and one base to be mechanically and electrically assembled into a tower with electrical communication between the base and each beacon module, the function generator comprising:
a housing;
first and second mechanical connectors positioned at a top and bottom of the housing adapted to releasably interlock with corresponding mechanical connectors of beacon modules and a base;
first and second electrical connectors positioned at a top and bottom of the housing adapted to releasably interface with corresponding electrical connectors of beacon modules and a base; and
a function generation circuit positioned within the housing and receiving electrical power from the second electrical connector to generate a time-modulation signal to provide time-modulated electrical power to the first electrical connector based on that time-modulated signal.

2. The function generator of claim 1 further including an oscillator providing a time reference for the time-modulation signal.

3. The function generator of claim 2 further including a switch communicating with the function generator circuit to change the time-modulated signal.

4. The function generator of claim 3 wherein the time-modulated electrical power is provided to multiple different conductors of the first electrical connector adapted to communicate with different beacon modules and wherein the switch selects which of the different electrical connectors receives modulated electrical power based on the time-modulated signal.

5. The function generator of claim 4 wherein the time-modulation signal provides synchronized modulation to the different conductors of the first electrical connector.

6. The function generator of claim 5 wherein the time-modulation signal provides synchronized different modulation to the different conductors of the first electrical connector.

7. The function generator of claim 1 wherein the housing further includes a power conversion circuit positioned within the housing and receiving electrical power from the second electrical connector having a parameter of at least one of voltage and mode to provide converted power to the function generator circuit for generation of the time-modulated electrical power.

8. The function generator of claim 1 wherein the first and second electrical connectors are of a same connector type such as would permit inter-engagement of the first and second electrical connectors and wherein the first and second mechanical connectors are of a same connector type such as would permit inter-engagement of the first and second mechanical connectors.

9. The function generator of claim 8 wherein the housing is substantially cylindrical and has a diameter substantially between 30 and 100 mm.

10. The function generator of claim 9 wherein the housing is substantially opaque and electrically insulating.

11. The power converter of claim 1 further including a power conversion circuit receiving signal lines from the second electrical connector and providing a source of electrical power derived from the signal lines to the function circuitry of the power conversion circuit, the function circuitry further modulating power on at least one signal line provided to the first electrical connector.

12. A stack light comprising:
a set of interconnected beacon modules, function generation module and base, wherein the interconnected beacon modules each provide;
(a) a transparent beacon light housing;
(b) first and second mechanical connectors positioned at a top and bottom of the beacon light housing releasably interlocked with corresponding mechanical connectors of corresponding beacon modules or the function generation module;
(c) first and second electrical connectors positioned at a top and bottom of the beacon light housing releasably interfaced with corresponding electrical connectors of beacon modules or the function generation module; and
(d) a lamp held within the housing and communicating with a connector element of the second electrical connector;
wherein the function generation module provides:
(a) a generator housing;
(b) first and second mechanical connectors positioned at a top and bottom of the generator housing, the first mechanical connector releasably interlocking with a corresponding mechanical connector of a given beacon module and the second mechanical connector releasably interlocking with a corresponding mechanical connector of the base;
(c) first and second electrical connectors positioned at a top and bottom of the generator housing, the first electrical connector releasably interfacing with a corresponding electrical connector of the given beacon module and the second electrical connector releasably interfacing with a corresponding electrical connector of the base; and
(d) a function generation circuit positioned within the generator housing and receiving electrical power from the second electrical connector to generate a time-modulation signal to provide time-modulated electrical power to the first electrical connector based on that time-modulated signal;
wherein the base provides:
(a) a base housing
(b) a first mechanical connector releasably interlocking with the second mechanical connector of the function generation module;
(c) a first electrical connector releasably interfacing with the second electrical connector of the function generation module;
(d) a terminal block electrically communicating with the first electrical connector; and
(e) a mounting flange providing openings for receiving machine screws to attach the mounting flange to a surface.

13. The stack light of claim 12 wherein the first and second electrical connectors of each beacon module are interconnected to provide an identical relative shifting of locations within each connector of the signal passing through the connector t route given signals to given beacon modules depending on a relative location of the beacon module in a stack with other beacon modules.

14. The stack light of claim 12 wherein the electrical connectors and mechanical connectors of each of different of the beacon modules, the function generation module, and the base are electrically and mechanically inter-operable with others of the beacon modules, the function generation module, and the base.

15. The stack light of claim 12 wherein a height of the function generation module between the first and second mechanical connectors is less than two-thirds of a height of a beacon module between the first and second mechanical connectors.

16. The stack light of claim 12 further including an oscillator providing a time reference lbr the time-modulation signal.

17. The stack light of claim 12 further including a switch communicating with the function generator circuit to change the time-modulated signal wherein the time-modulated electrical power is provided to multiple different conductors of the first electrical connector adapted to communicate with different beacon modules and wherein the switch selects which of the different electrical connectors receive modulated electrical power based on the time-modulated signal.

18. The stack light of claim 17 wherein the time-modulation signal provides synchronized modulation to the different of the first electrical connector.

19. The function stack light of claim 18 wherein the time-modulation signal provides synchronized different modulation to the different conductors of the first electrical connector.
